(19) United States
(12) Patent Application Publication
(10) Pub. No.: US 2002/0145518 A1
(43) Pub. Date: Oct. 10, 2002

(54) External notification of multimedia computer events

(76) Inventors: Robert E. Smith, Lake Linden, MI (US); Edward Lumsdaine, Hancock, MI (US)

Correspondence Address: Robert E. Smith, 476 Poplar Street, Lake Linden, MI, 49945, US

(21) Appl. No.: 10/068,696

(22) Filed: Feb. 5, 2002

Related U.S. Application Data
(60) Provisional application No. 60/266,726, filed on Feb. 5, 2001.

(51) Int. Cl. G08B 21/00

(52) U.S. Cl. 340/540; 340/286.01

(57) ABSTRACT

The present invention provides a new method to alert the computer operator to events. The inventive device includes a computer, the computer sound file, an audio connection, and an alerting device. The computer will preferably present text, graphics, video, animation, and sound in an integrated way. In addition, it will play operator-selectable sound files in response to an event. A sound file comprises a quantity of data that may be decoded as an audible sound. For this invention, the sound file will additionally contain a distinct sound known as a trigger-sound. The alerting device plugs into the audio-output port on the computer and allows the speakers to be connected inline. The alerting device selectively activates on computer output of the trigger-sound to gain operator attention. Example alerting devices include: a wireless pager, incremental counter, an animated figure, or a flashing light.

### BACKGROUND OF THE INVENTION

1. Field of the Invention

The present invention relates to computer peripherals and more specifically to a method that externally alerts the computer operator to computer events.

2. Description of the Prior Art

It can be appreciated that techniques have been employed for years to alert the computer operator to events such as errors or new email. Multimedia operating systems customarily alert the end-user by playing a “sound file” and/or displaying messages. Commercial examples of this are Microsoft Corporation's Windows, Apple Computer's Mac OS, and Unix or Linux Based X-Windows. These operating systems allow various events, such as incidence of an error email, to be configured to play a sound. Most programs also incorporate similar designs; an email program may play a specific sound when an email is received. The main problem with the conventional alerting technique is that it binds the operator to the computer system. The operator must listen for sounds or watch the computer screen.

Recognition of this problem led to the design of specialized monitoring systems that wirelessly page the operator. The major problem with these systems is they are both task and system specific. For example, a Microsoft Windows alert system that pages the operator when he or she receives new email is limited to an IBM compatible machine running the Microsoft Windows Operating System. The operator has little control over function without reprogramming said system. In some cases, additional hardware is required as well. For example, paging via a typical commercial paging system requires a modem capable of dialing the commercial system over the telephone line. Existing paging systems are specific and expensive.

It is also appreciated that computers have been used for years to control complex movement in toys; U.S. Pat. No. 6,012,961 represents the latest art in animatronics. The problem with this category of devices is they function as toys and not as event-specific alerts devices. Another problem is toy devices use the computer to control movement and may require complicated signals that may interfere with normal use of the computer communications ports. Another problem with these devices is they may require special software and hardware to function. Yet another problem is these devices react to set signals and cannot be daisy chain connected.

While these prior devices may be suitable for the particular purpose to which they address, they are not as suitable for externally alerting the computer operator to an event that occurs in the computer. The main problem with conventional notification techniques is they bind the operator to the computer and may depend on additional computer software and possibly additional hardware. This leads to a lack of flexibility.

In these respects, the external notification of multimedia computer events according to the present invention substantially departs from the conventional concepts, designs and intent of the prior art, and in so doing provides an apparatus primarily developed for the purpose of externally alerting the computer end-user to an event that occurs in the computer.

### SUMMARY OF THE INVENTION

In view of the foregoing disadvantages inherent in the known types of event notification techniques now present in the prior art, the present invention provides a new method to alert the computer operator to events wherein the same can be utilized for external notification for use with a multimedia computing device.

The general purpose of the present invention, which will be described subsequently in greater detail, is to provide a new method for external notification of multimedia computer events that has many of the advantages of the event notification technique mentioned heretofore and many novel features that result in a new external notification of multimedia computer events which is not anticipated, rendered obvious, suggested, or even implied by any of the prior art event notification technique, either alone or in any combination thereof.

To attain this, the present invention generally comprises a computer, a computer sound file, an audio connection, and an alerting device. The computer will preferably present text, graphics, video, animation, and sound in an integrated way. In addition, it will be capable of playing operator-selectable sound files in response to an event. The sound file comprises a quantity of data that may be decoded as an audio signal. For this invention, the sound file will additionally contain a triggering tone, sequence of tones, or other distinct signal called hereafter a trigger-sound. The preferable audio connection would attach to audio-output port on the computer and allow the speakers to be connected inline with the alerting device. The alerting device receives the audio signal and selectively activates upon detection of the trigger-sound to gain operator attention. This indirect interface with the computer processor is hereafter called external notification. Example alert devices include: a wireless pager, incremental counter, an animated figure, or a flashing light.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of the description and should not be regarded as limiting.

A primary object of the present invention is to provide an external notification of computer events that will overcome the shortcomings of the prior art devices.

Another object of the present invention is to maximize flexibility of use for the end-user.

Another object is to provide an external notification of multimedia computer events that requires no additional software or computer hardware for operation.

Another object is to provide an external notification of multimedia computer events that is capable of selectively passing audio messages from the sound card to the end-user.

Other objects and advantages of the present invention will become obvious to the reader and it is intended that these objects and advantages are within the scope of the present invention.

To the accomplishment of the above and related objects, this invention may be embodied in the forms illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an attention-getting device in the form of a motorcycle that alerts the end-user via sound and lights.

FIG. 2 is a functional diagram of the attention-getting motorcycle of FIG. 1. Additionally shown is a second device connected in a daisy-chain manner.

FIG. 3 shows a wireless paging system functioning as the attention-getting device.

FIG. 4 is a functional diagram of the wireless paging system of FIG. 3.

FIG. 5 illustrates the construction of the sound file that contains a trigger-sound and audio message portion.

FIG. 6 shows a typical Microsoft Windows screen where the operator selects which sound file will play for certain events.

FIG. 7 illustrates the use of an activation box that contains all the electronics and relays to turn multiple alerting devices on and off.

FIG. 8 is a functional diagram of the activation box from FIG. 7.

REFERENCE NUMERALS IN THE DRAWINGS

| | | | |
|---|---|---|---|
| 10 | computer | 22 | left speaker |
| 12 | sound file | 24 | right speaker |
| 12A | trigger-sound | 26 | speaker audio connector |
| 12B | audio message | 28 | activation sound selector switch |
| 14 | alerting device #1 | 32 | wire |
| 14A | alerting device transmitter | 34 | additional alerting device #1 |
| 14B | alerting device receiver | 35 | additional device #1 |
| 16 | speakers assembly | | sound selector switch |
| 18 | inline audio connector | 36 | additional alerting device #2 |
| 20 | computer audio-output port | 38 | timer |
| | | 40 | activation box |

### DESCRIPTION OF THE PREFERRED EMBODIMENT

Turning now descriptively to the drawings, in which similar reference characters denote similar elements throughout the several views, the attached figures illustrate a method to alert the computer operator to events.

Components

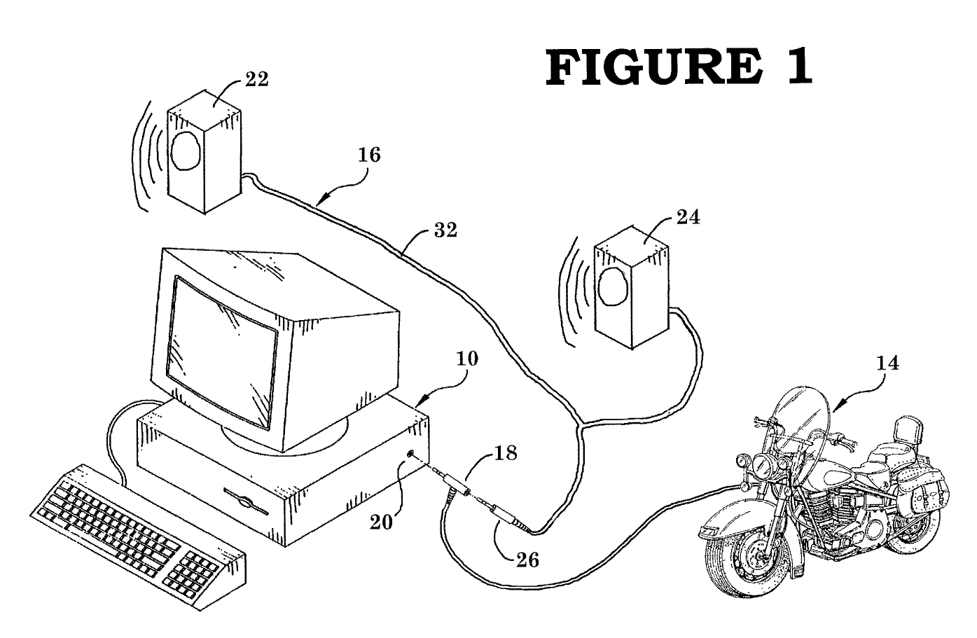

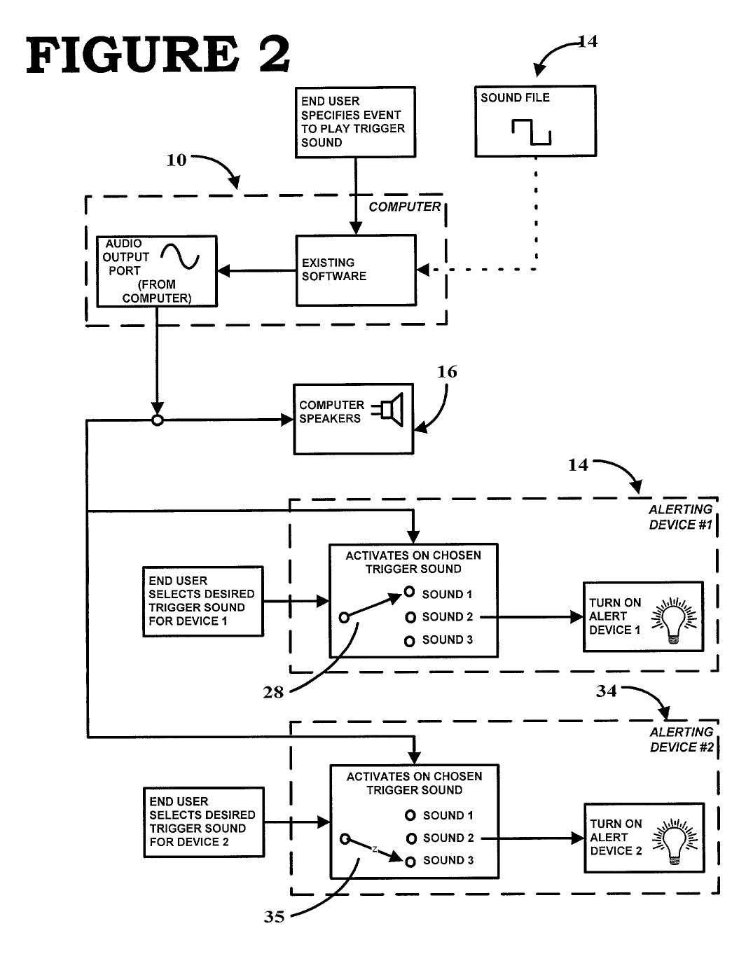

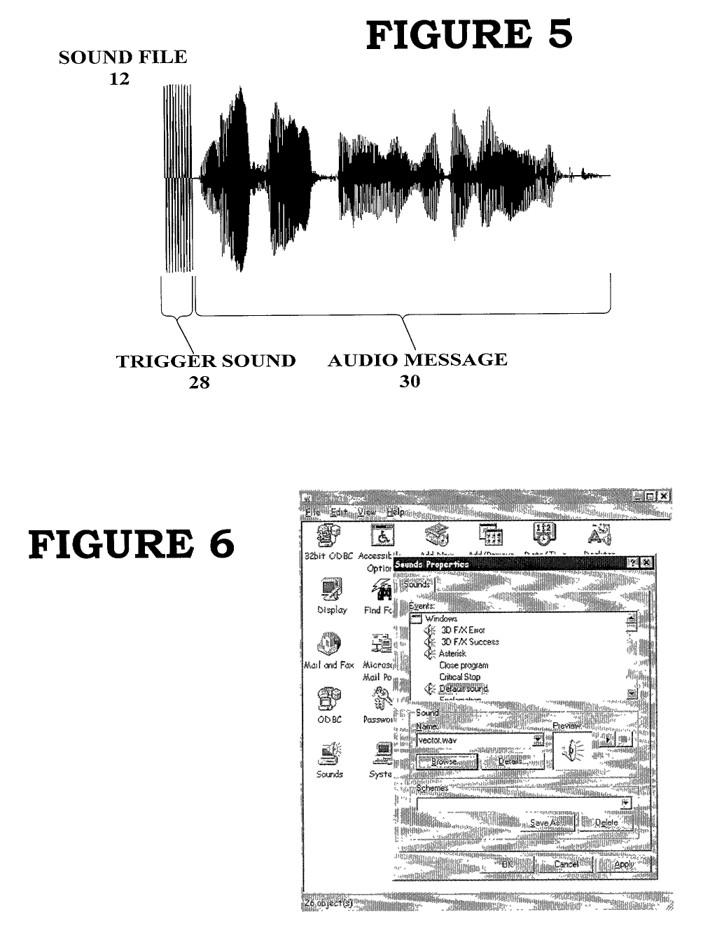

The preferred embodiment is shown in FIG. 1 and FIG. 2, which comprise a computer 10, the computer sound file 12, an inline audio connector 18, and an alerting device 14. The computer 10 will be multimedia based and allow the operator to select which sound file 12 to play in response to an event. The sound file 12 detailed in FIG. 5 comprises a portion of data that is intended to be decoded as an audible sound 12B and for the present invention will further contain a distinct trigger-sound 12A. The inline audio connector 18 plugs into the audio sound-output port 20 on the computer 10 and allows connection of both the alerting device and speaker assembly 16. The alerting device 14 selectively activates upon detection of the trigger-sound 12A output from the computer to gain operator attention. Example alert devices include: a wireless pager, incremental counter, an animated figure, or a flashing light.

The computer 10 will preferably present text, graphics, video, animation, and sound in an integrated way. In addition, it will be capable of playing operator-selectable sound files 12 in response to an event. Example events are errors; new email; and incoming telephony. The computer 10 provides an audio-output port 20. The computer may be optionally equipped with a speaker assembly 16 or headphones. Any multimedia based computing appliance could be substituted for computer 10. Substitutes include workstations and Internet appliances. Workstations are typically more powerful than a computer and may include external processing over a network. Internet appliances include handheld devices and those intended for playing audio feed over the Internet.

A sound file as shown in detail in FIG. 5 comprises a collection of data stored digitally on the computer and will be decoded as an audible sound. The de facto standard for a sound file at this current time is the WAV format that was developed by International Business Machines and is the standard format for the Microsoft Windows Operating System. For this invention, the sound file 12 will contain a trigger-sound 12A. The trigger-sound 12A could be a tone, series of tones, or any distinct arbitrary sound. The preferable trigger-sound 12A will be one that is not produced at random by use of the computer such as during music play. More than one trigger-sound may be included in the sound file 12 depending on the application. The sound file 12 may be stored on a fixed media or removable media or produced over the Internet.

The inline audio connector 18 allows the alerting device to be connected inline with the speakers 16 without interrupting the speaker operation. The inline connector is also useful for connecting more than one alerting device, shown in FIG. 2. FIG. 1 shows a wired connection between the computer 10 and a single alerting device 14. In addition, a wireless means may replace the wired connection. For example, a microphone may listen to computer speaker 16 output. Further, it is possible to eliminate all audio output dependence by building detection directly into a sound card.

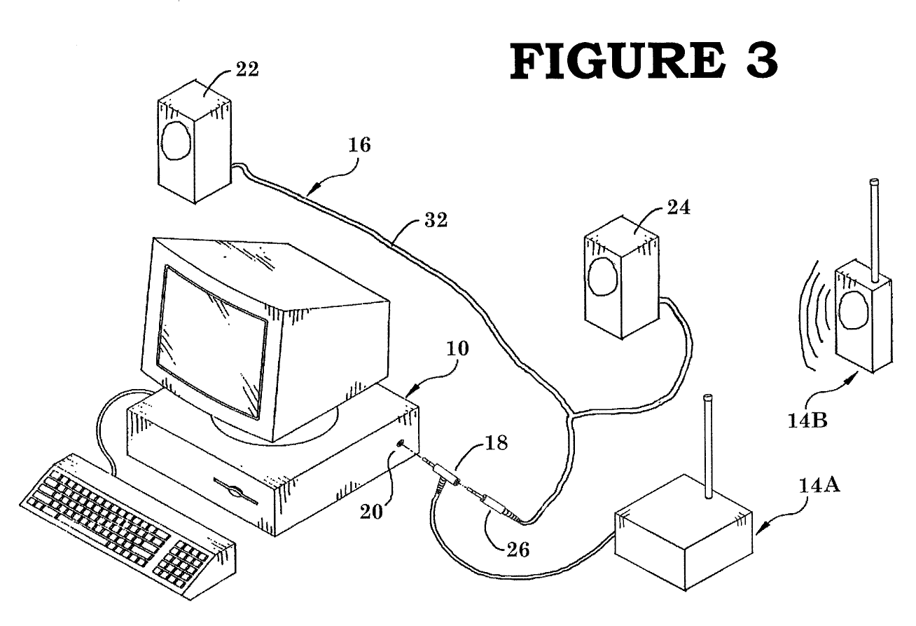

The alerting device 14 selectively activates upon detection of the trigger-sound 12A to gain operator attention. There are several variations of the alerting device shown. FIG. 1 shows the electronics mounted inside an alerting device 14 fashioned to appeal to a Harley Davidson motorcycle enthusiast. Once triggered the device 14 might rev it's motor and flash the headlights. FIG. 3 shows a wireless pager as the alerting device. The pager, as shown in FIG. 3 & 4, includes a wireless transmitter 14A and receiver 14B. The pager preferably transmits audio once triggered or may produce vibration or sound alerts on the receiver 14B. Another possible alerting device is an incremental counter that increments or decrements upon each event (not illustrated in the figures). For example, the counter could be affixed to the computer 10 monitor to provide an at-a-glance reading of incoming email.

General Operation

The pager and other attention-getting devices use the same overall process as diagrammed in FIG. 2. First, the operator enters the software setup and configures the computer to play a specific sound file 12 when a desired event occurs. To make an event, such as an error, activate the alerting device 14 the sound file selected must contain a trigger-sound 12A. This is in contrast to playing a sound file that does not contain a trigger-sound and will produce no triggered response. FIG. 6 shows the setup screen from the Microsoft Windows control panel. The operator then sets switch 28 on the alerting device 14 to activate on the correct trigger-sound from a plurality of possibilities. This allows connection of multiple alerting devices—each activating on a different trigger-sound.

Next, the operator goes about his/her day, and the proposed alert device(s) 14 listens to sound card output, waiting for the trigger-sound 12A. When the device detects the sound, it performs an external event such as wirelessly paging the operator or activating an attention-getting device. Since the system runs inline with the speakers 16 and listens to audio output, it will not interfere with normal computer 10 operation. Note this process, requires only sound files and no additional computer hardware or software.

A non-exhaustive list of common events a operator may desire to monitor with the present invention follows: receipt of new email messages; incoming telephony; completion of a file download; conclusion of long computations; warning of stock prices; completion of burning a compact disc; weather warning from the Internet; reminder of an appointment; ending of a software installation; receipt of an incoming fax; receipt of instant messages; user-online notification; and occurrence of an error.

Pager Embodiment Operation

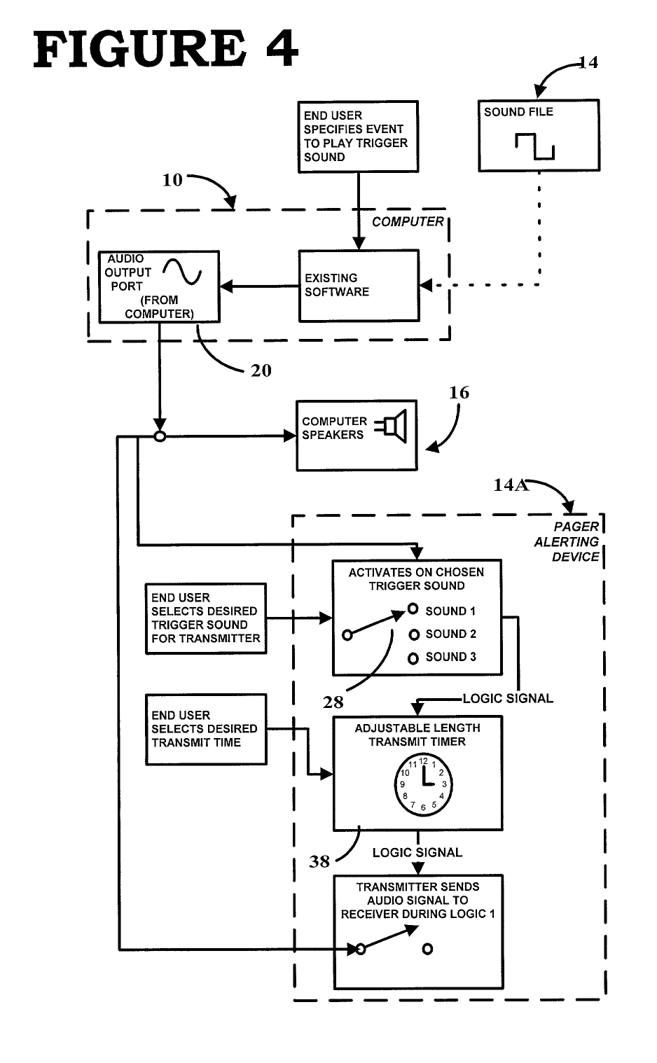

Pager operation is shown in FIG. 4. The prior-described, FIG. 2, process would work with a simple wireless transmitter 14A to cause a vibration or beep on the receiver 14B. However, an additional desire is to transmit the audio message 30 from the sound file 12. Timer 38 forces transmission of remaining audio from the audio-output port 20 for a length of time after detection of the trigger-sound 12A. A second trigger-sound may also be used to end transmission.

Activation Box Embodiment Operation

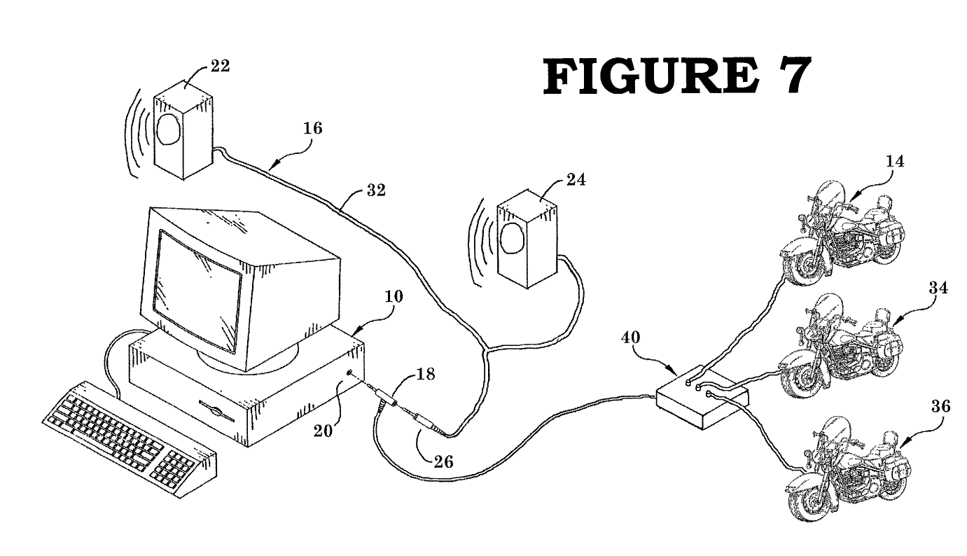

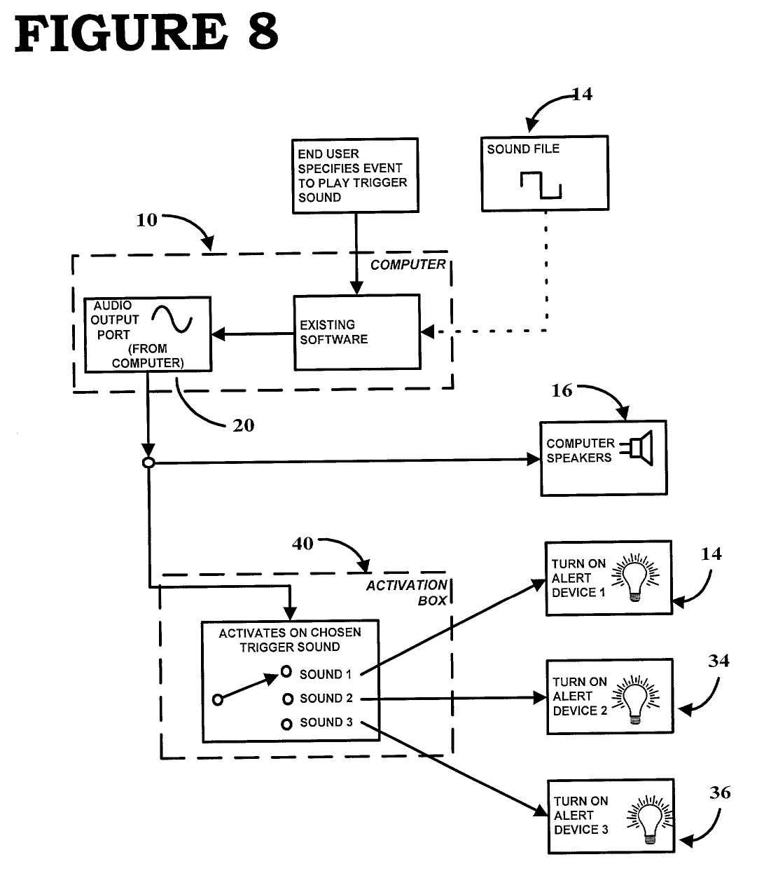

FIGS. 7 & 8 show an embodiment that mounts all the detection electronics in an activation box 40 separate from shown multiple alerting devices 14, 34, 36. When the activation box 40 detects a trigger-sound, it closes an appropriate relay that turns on the desired alerting device. The alerting devices 14, 34, 36 are connected to the activation box 40 in a removable manner, most likely a plug. In this way, the operator can interchange multiple alerting devices while not requiring each device to have its own electronics. Further, an adept operator could modify anything that activates via a switch to work with the activation box.

Alternative Embodiments

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for detecting a computer event and alerting the operator externally comprising:
providing a computer that produces a sound signal to alert the computer operator some event has occurred as part of the operating environment;
providing at least one unique trigger sound said operator may select as the sound signal to output for a plurality of computer events;
said operator configures said computer to output said sound that contains said trigger sound;
an external alerting means will:
monitor said sound output for said unique trigger sound;
externally notify operator that a specific trigger sound was detected;
whereby a single alerting device may provide a plurality of responses matching unique trigger sounds, and
whereby a plurality of alerting devices may respond independently to matched unique trigger sound.

2. The unique trigger sound of claim 1 is a combination or sequence of tones that the alerting means of claim 1 can discern as different than normally output sound signals, preventing accidental alerts.

3. The unique trigger sound of claim 1 is played concurrently with normal sound output to control the duration of the alerting event.

4. The specific sound of claim 1 contains more than one trigger sound to signal the alerting means to end an alert.

5. The alerting means of claim 1 wherein said the alerting means monitors sound output is connected inline with speakers.

6. The alerting means of claim 5 where more than one alerting device is connected inline.

7. The alerting means of claim 1 wherein said the alerting means monitors sound output uses a microphone to monitor sound output.

8. The alerting means of claim 1 is connected wirelessly and operates as a wireless pager.

9. The alerting means of claim 1 is intended to be statically located and operate as an attention getting device.
